(19) United States
(12) Patent Application Publication
(10) Pub. No.: US 2014/0061205 A1
(43) Pub. Date: Mar. 6, 2014

(54) NON-STICK COOKWARE

(71) Applicant: Te-Ming Chiu, Tainan (TW)

(72) Inventor: Te-Ming Chiu, Tainan (TW)

(21) Appl. No.: 13/606,003

(22) Filed: Sep. 6, 2012

(51) Int. Cl. A47J 36/00

(52) U.S. Cl. 220/573.2

(57) ABSTRACT

A non-stick cookware has a base and a non-stick net layer. The non-stick net layer is formed on a top surface of the base and has multiple non-stick elements. Each non-stick element has an enclosing wall and a recess enclosed by the enclosing wall. Each enclosing wall has multiple top edges, multiple bottom edges, multiple outer arc corners and multiple inner arc corners. The outer arc corners are respectively formed in the top edges. The inner arc corners are respectively formed in the top edges. The outer arc corners and the inner arc corners can provide multiple cambered surfaces.

### BACKGROUND OF THE INVENTION

1. Field of the Invention

The present invention relates to a non-stick cookware, and more particularly to a non-stick cookware to provide a non-stick effect and ease in cleaning.

2. Description of Related Art

A conventional cookware has a base. The base has a smooth curved cooking surface. During the cooking process, food easily sticks on the cooking surface, causing inconvenience in cooking and cleaning. Responsive to said defect, a non-stick cookware is developed with the cooking surface coated with a non-stick coating such as polytetrafluoroethylene (PTFE) coating to prevent food from sticking on the cooking surface.

During the cooking process, a cooking utensil, such as a spatula or a turner, frequently scrapes against the non-stick coating of the conventional non-stick cookware, and the non-stick effect of the cookware is decreased by a damage to the non-stick coating of the cookware. Further responsive to the shortcoming, a non-stick net portion is formed on and protrudes from the cooking surface. Multiple recesses are enclosed by the non-stick net portion to reduce the contact area between food and the cooking surface and further to increase the non-stick effect.

The non-stick net portion is formed on the cooking surface of the cookware directly and forms multiple dead corners that are tiny and pointy, causing food residue and filth to remain in the recesses, so the conventional cookware with the non-stick net portion is not easy to be clean up.

To overcome the shortcomings, the present invention tends to provide a non-stick cookware to mitigate or obviate the aforementioned problems.

### SUMMARY OF THE INVENTION

The main objective of the invention is to provide a non-stick cookware being easy to clean up.

The non-stick cookware has a metal body. The metal body has a base, a non-stick net layer and a side wall. The non-stick net layer is formed on and protrudes from a top surface of the base and has multiple non-stick elements. Each non-stick element has an enclosing wall and a recess enclosed by the enclosing wall. The enclosing walls are formed on and protrude from the top surface and each enclosing wall has multiple top edges, multiple bottom edges, multiple outer arc corners and multiple inner arc corners. The bottom edges are adjacent to the top surface of the base. The outer arc corners are respectively formed in the top edges. The inner arc corners are respectively formed in the top edges. The side wall is formed around and protrudes from the base circumferentially.

Further, each enclosing wall has multiple straight parts mounted around the recess, and has multiple side arc corners. Each side arc corner is defined in a position adjacent to two of the straight parts and is connected to the top surface of the base

The non-stick net layer has many recesses to reduce the contact area between food and the top surface of the base and further to increase the non-stick effect without coating a chemical substance. Furthermore, the non-stick net layer has multiple outer arc corners, multiple inner arc corners and further has side arc corners to provide multiple cambered surfaces to avoid a sharp corner forming on the enclosing walls. Therefore, the non-stick cookware is easy to clean up.

Other objects, advantages and novel features of the invention will become more apparent from the following detailed description when taken in conjunction with the accompanying drawings.

### BRIEF DESCRIPTION OF THE DRAWINGS

FIG. 1 is a top view of a non-stick cookware in accordance with the present invention;

FIG. 2 is an enlarged partial top view of the non-stick cookware in FIG. 1; and

FIG. 3 is a cross sectional side view of the non-stick cookware in FIG. 1 along line 3-3 in FIG. 2; and

FIG. 4 is an enlarged partial side view of the non-stick cookware in FIG. 3.

### DETAILED DESCRIPTION OF PREFERRED EMBODIMENT

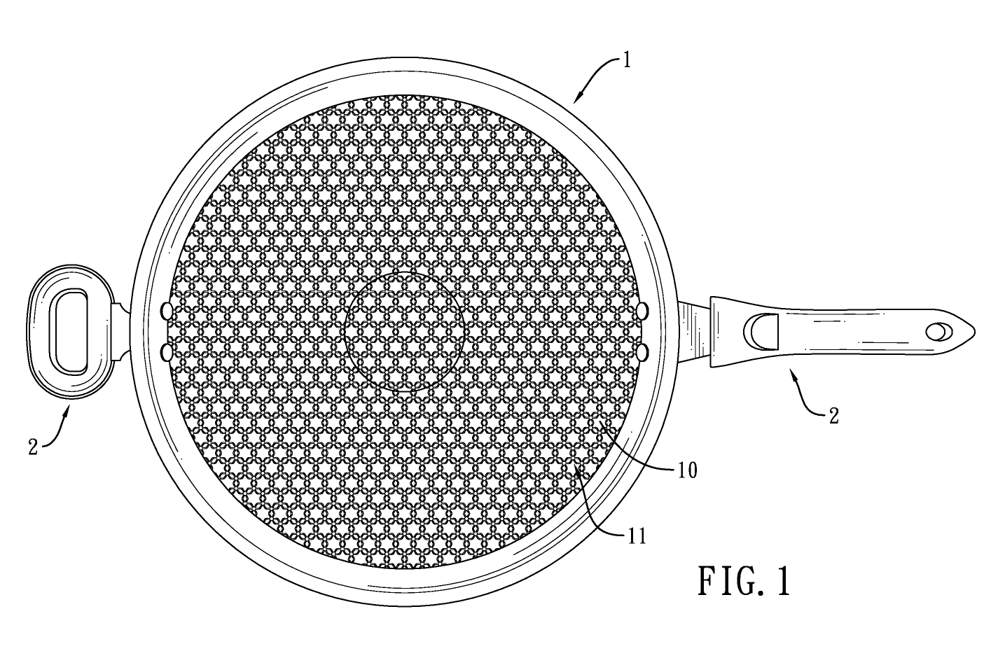

With reference to FIG. 1, a non-stick cookware in accordance with the present invention has a metal body 1 and at least one handle 2. The at least one handle 2 is mounted on the metal body 1 to be held by users.

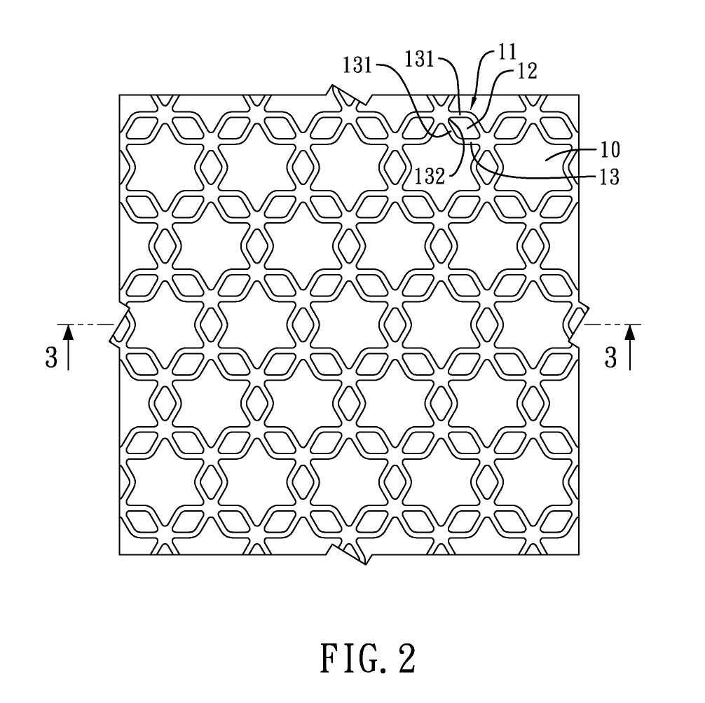

The metal body 1 is made of metal, such as stainless steel. The metal body 1 has a base 10, a side wall and a non-stick net layer 11. The base 10 has a top surface. The side wall is formed around and protrudes from the base 10 circumferentially. The non-stick net layer 11 is formed on and protrudes from the top surface of the base 10 and has multiple non-stick elements. Each non-stick element has an enclosing wall 13 formed on and protruding from the top surface of the base 10 and has a recess 12 enclosed by the enclosing wall 13. With reference to FIG. 2, the recesses 12 have a polygonal cross section, such as a star or a rhombus.

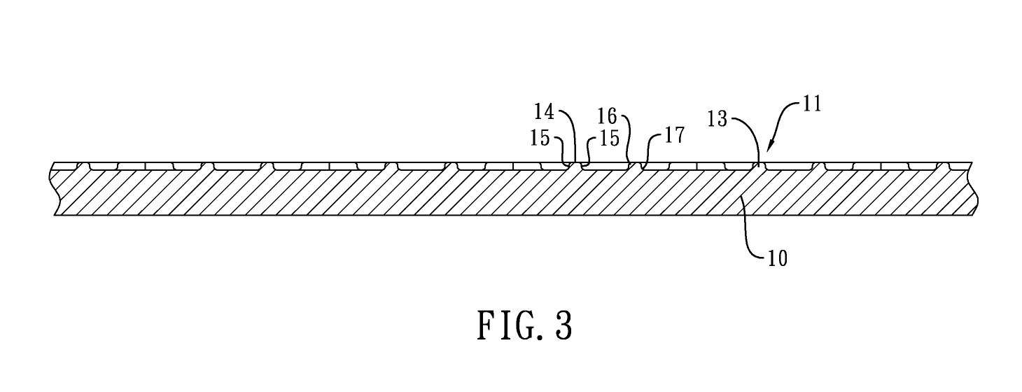

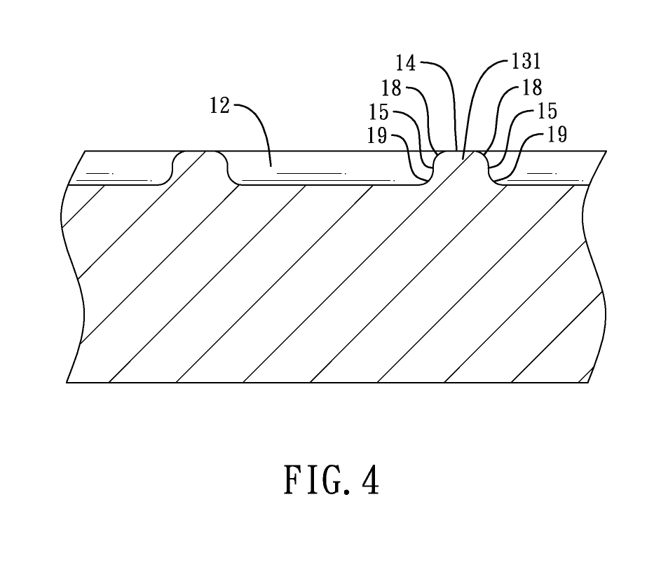

With reference to FIGS. 3 and 4, each enclosing wall 13 is formed on and protrudes from the top surface of the base 10, and has a distal surface 14, two side surfaces 15, multiple top edges 16, multiple bottom edges 17, multiple outer arc corners 18 and multiple inner arc corners 19. The side surfaces 15 are arranged at an interval and each side surface 15 connects the distal surface 14 and the top surface of the base 10. Each top edge 16 is defined in a position adjacent to the distal surface 14 and one of the side surfaces 15. Each bottom edge 17 is defined in a position adjacent to the top surface of the base 10 and one of the side surfaces 15. The outer arc corners 18 are respectively formed in the top edges 16. The inner arc corners 19 are respectively formed in the bottom edges 17.

Furthermore, each enclosing wall 13 has multiple straight parts 131 and multiple side arc corners 132. The straight parts 131 are mounted around the recess 12. The side arc corners 132 are respectively defined in a position adjacent to two of the straight parts 131 and each side arc corner 132 is connected to the top surface of the base 10. The thickness of the straight parts 131 is 0.06 mm to 5 mm, and the height of the straight parts 131 is 0.03 mm to 0.4 mm.

During the cooking process, the non-stick net layer 11 protruding from the top surface of the base 10 can reduce the contact area between food and the top surface of the base 10. Moreover, each recess 12 provides a space to contain oil or liquid and produce a separating effect between food and the base 10. Therefore, the non-stick cookware has a good non-stick effect without coating a chemical substance, and damage of the metal body 1 is prevented.

Furthermore, the non-stick net layer 11 has multiple outer arc corners 18, multiple inner arc corners 19 and further has side arc corners 132 to provide multiple cambered surfaces to avoid a sharp corner forming on the enclosing walls 13. Therefore, the non-stick cookware is easy to clean up.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A non-stick cookware comprising:
a metal body having:
a base having:
a flat top surface;
a non-stick net layer formed on and protruding from the flat top surface and having multiple non-stick elements, each non-stick element having:
an enclosing wall formed on and protruding from the flat top surface and having:
a flat distal surface;
two side surfaces arranged at an interval and connecting to the flat distal surface and the flat top surface of the base;
multiple top edges, each top edge being defined in a position adjacent to the flat distal surface and one of the side surfaces;
multiple bottom edges, each bottom edge being defined in a position adjacent to the flat top surface of the base and one of the side surfaces;
multiple outer arc corners respectively formed in the top edges; and
multiple inner arc corners respectively formed in the bottom edges; and
a recess enclosed by the enclosing wall; and
a side wall formed around and protruding from the base circumferentially.

2. The non-stick cookware as claimed in claim 1, wherein
each enclosing wall has
multiple straight parts mounted around the recess, and
multiple side arc corners respectively defined in a position adjacent to two of the straight parts and each side arc corner connected to the flat top surface of the base.

3. The non-stick cookware as claimed in claim 2, wherein the thickness of each straight part is 0.06 mm to 5 mm, and the height of each straight part is 0.03 mm to 0.4 mm.
